(19) United States
(12) Patent Application Publication
(10) Pub. No.: US 2018/0173367 A1
(43) Pub. Date: Jun. 21, 2018

(54) SENSOR-EQUIPPED DISPLAY DEVICE, CONTROL DEVICE, AND CONTROL METHOD

(71) Applicant: SHARP KABUSHIKI KAISHA, Sakai City, Osaka (JP)

(72) Inventor: MASASHI MAYUMI, Sakai City (JP)

(21) Appl. No.: 15/576,500

(22) PCT Filed: May 23, 2016
(86) PCT No.: PCT/JP2016/065209

§ 371 Date: Nov. 22, 2017

(30) Foreign Application Priority Data
May 26, 2015 (JP) 2015-106616

(51) Int. Cl. G06F 3/041; G06F 3/044

(52) U.S. Cl. CPC G06F 3/0418; G06F 3/0412; G09G 3/3648; G06F 2203/04108; G06F 3/044

(57) ABSTRACT

A sensor-equipped display device includes a scanning driving unit (4) that repeats a scanning operation of sequentially selecting a plurality of display scanning lines (G) in a first direction, and a data driving unit (5) that applies voltages to a plurality of data lines (S). Further, the sensor-equipped display device includes a detection control unit (30) that repeats a scanning operation of sequentially driving a plurality of detection scanning lines (DIAL) in the first direction, and detects signals of detection lines (SNL). The detection control unit (30) is capable of switching a first operation and a second operation. The first operation controls timings of the pulses of the driving signal based on timings of signal output to the data lines. The second operation outputs a driving signal having pulses of a frequency that is different from a frequency of the signal output to the data lines.

### TECHNICAL FIELD

The disclosure of the present application relates to a sensor-equipped display device that includes a screen that displays an image, and a sensor that detects contact or approach of an object with respect to the screen.

### BACKGROUND ART

In recent years, a sensor-equipped display device that includes a display unit including a screen that displays an image, and a touch panel that detects contact or approach of an object such as a finger or a pen with respect to the screen has been commercialized. In the sensor-equipped display device, driving signals for the display unit can be noise and exert influences on the touch panel. Besides, the driving signals for the touch panel also can be noise for the display unit. The display unit and the touch panel can interfere with each other in this way, which causes the respective signal-noise (SN) ratios to decrease, resulting in that malfunctions occur, or the detection accuracy or the display quality deteriorate, in some cases.

In order to suppress the interference between the display unit and the touch panel, the controlling is performed with the driving timing of the display unit and the driving timing of the touch panel being associated with each other. For example, in the display device having a touch detection function disclosed in Patent Document 1 indicated below, the display elements are driven in such a manner that M horizontal lines are sequentially displayed in each of a plurality of unit driving periods that compose one frame period. Further, touch detection elements are driven during N touch detection periods provided in the unit driving period, N being smaller than M.

In this way, one frame period is divided into a period for display and a period for detection on the touch panel, and the driving for display and the driving for detection are executed sequentially, whereby interference with each other can be suppressed.

### PRIOR ART DOCUMENT

### Patent Document

Patent Document 1: JP-A-2013-84168

### SUMMARY OF THE INVENTION

### Problem to be Solved by the Invention

If the resolution of the display unit is increased, a period required for driving the display unit increases. If the time required for driving the display unit increases, the period that can be assigned for the touch panel decreases, which makes it difficult to balance the driving of the display unit and the driving of the touch panel well. Besides, if a sufficient period for driving the touch panel cannot be ensured, this can deter the performance of the touch panel from improving.

Besides, the driving of the touch panel is also influenced, not only by noises from the driving signals of the display device, but also by exogenous noise caused by something other than the display device, such as electronic components, lines, and the like arranged therearound. The touch panel, therefore, is preferably robust to exogenous noise, too.

The present application discloses a sensor-equipped display device, a control device, and a control method that are capable of suppressing influences of display operations and exogenous noise to a detection operation for detecting an object with respect to a screen that displays an image, while ensuring sufficient time for the detection operation.

### Means to Solve the Problem

A sensor-equipped display device in one embodiment of the present invention relates to a sensor-equipped display device that includes a screen that displays an image, and a sensor that detects contact or approach of an object with respect to the screen. The sensor-equipped display device includes: a plurality of display scanning lines that are arrayed in a first direction; a plurality of data lines that are arrayed in a second direction that is different from the first direction; a plurality of switching elements that are provided in correspondence to points of intersection between the display scanning lines and the data lines, respectively; and a plurality of pixel electrodes that are connected to the switching elements, respectively.

Further, the sensor-equipped display device includes: a scanning driving unit that repeats a screen scanning operation with respect to the display scanning lines, the screen scanning operation with respect to the display scanning lines being an operation of selecting the display scanning lines sequentially in the first direction throughout the screen; and a data driving unit that outputs a signal to the data lines in synchronization with the scanning of the display scanning lines by the scanning driving unit, thereby applying, to the pixel electrodes, voltages corresponding to gray levels to be displayed, respectively.

The sensor-equipped display device further includes: a plurality of detection scanning lines that are arrayed in the first direction; a plurality of detection lines that are arrayed in the second direction; and a detection control unit that repeats a screen scanning operation of outputting a driving signal that includes a plurality of pulses, to the detection scanning lines sequentially, and detects signals of the detection lines in correspondence to the driving signal to the detection scanning lines.

The detection control unit is capable of switching a first operation and a second operation from one to the other. The first operation is an operation that controls timings of the screen scanning operation with respect to the detection scanning lines based on timings of the screen scanning operation with respect to the display scanning lines, and controls timings of the pulses of the driving signal based on timings of signal output to the data lines. The second operation is an operation that controls timings of the screen scanning operation with respect to the detection scanning lines based on timings of the screen scanning operation with respect to the display scanning lines, and outputs a driving signal having pulses of a frequency that is different from a frequency of the signal output to the data lines.

### EFFECT OF THE INVENTION

According to the disclosure of the present application, in the sensor-equipped display device, influences of display operations and exogenous noise to a detection operation for detecting an object with respect to a screen that displays an image can be suppressed, while sufficient time can be ensured for the detection operation.

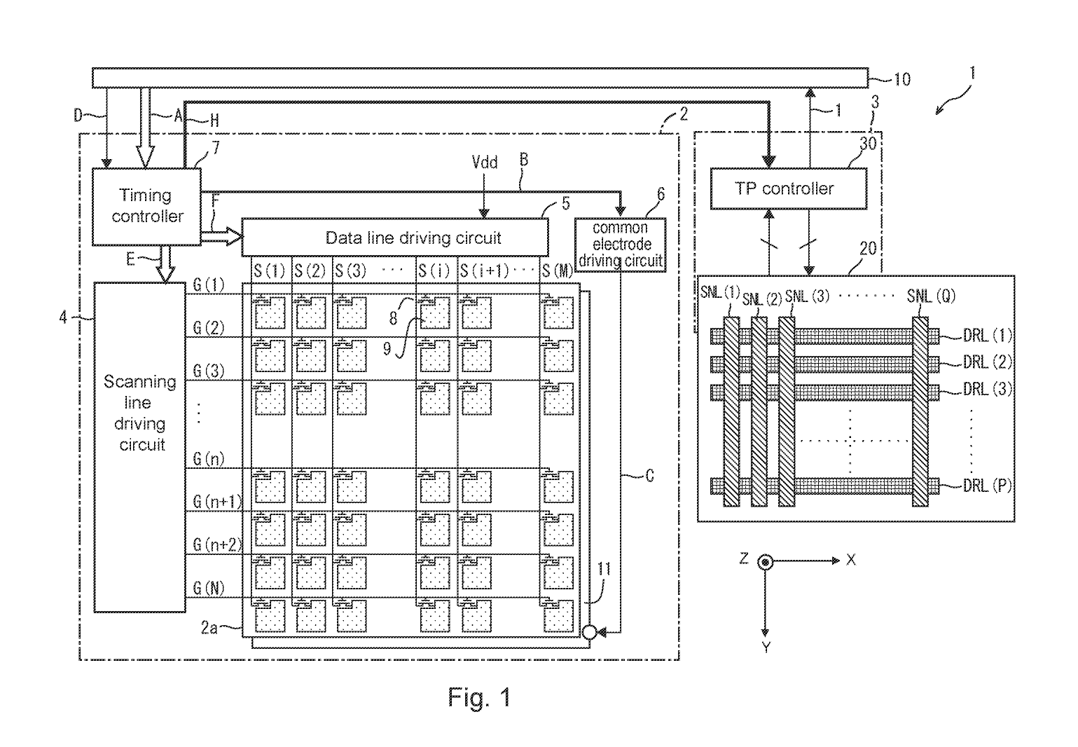

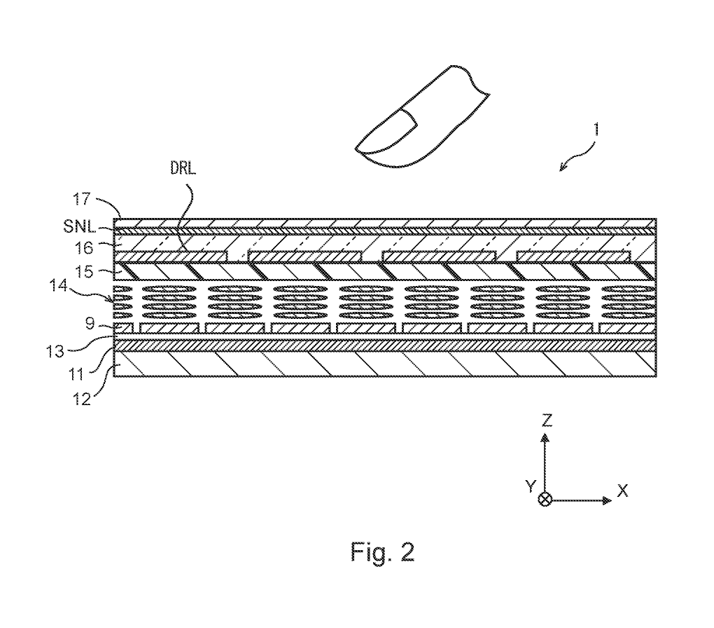

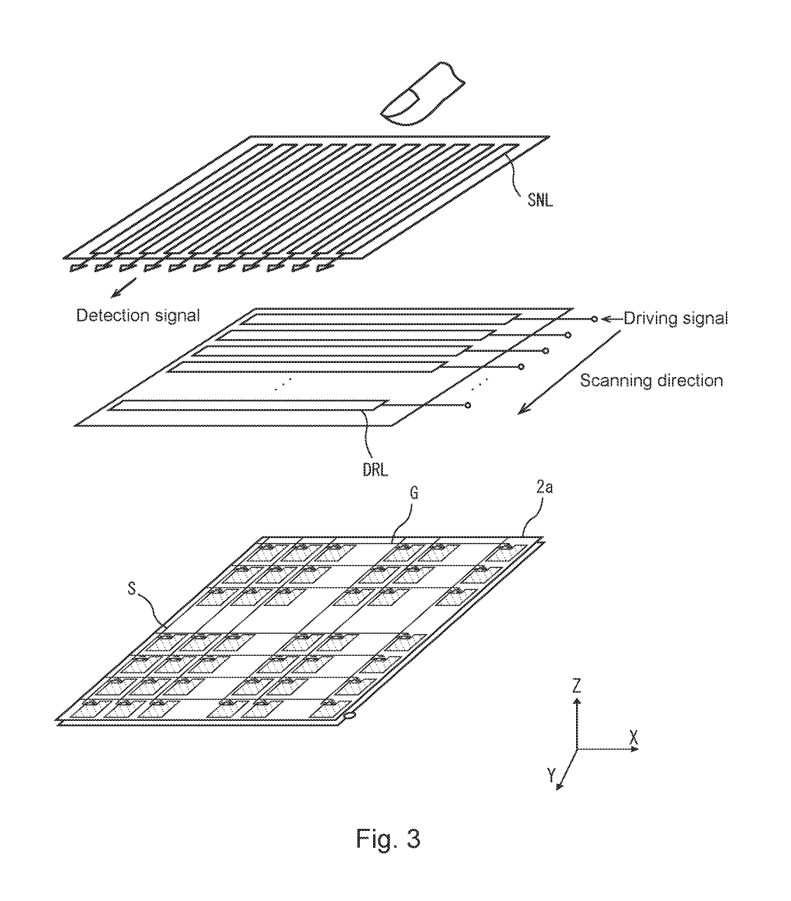

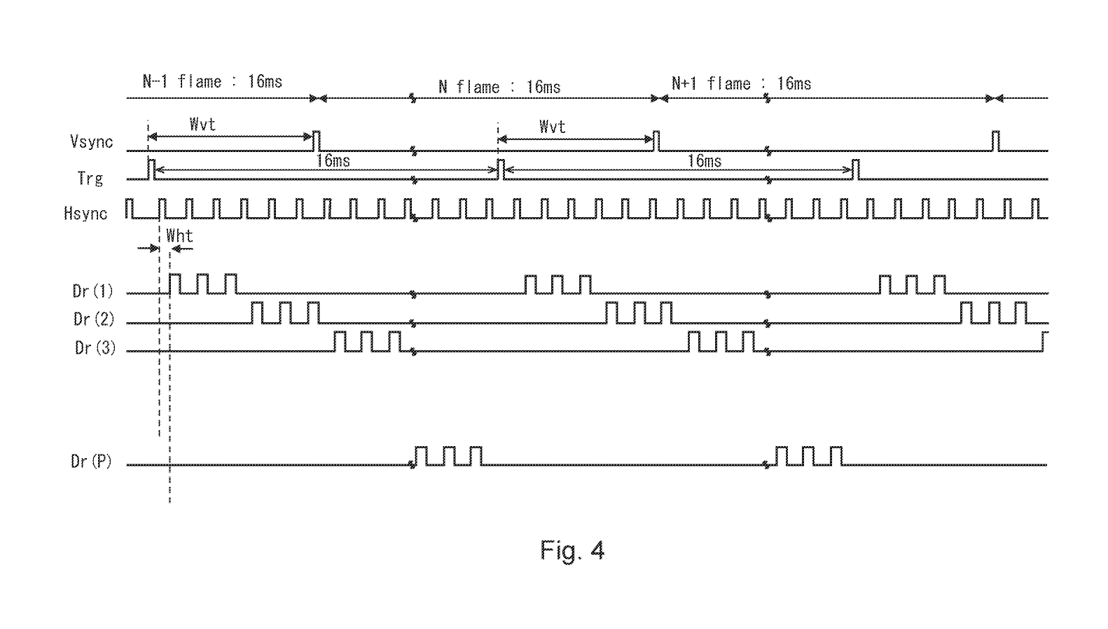

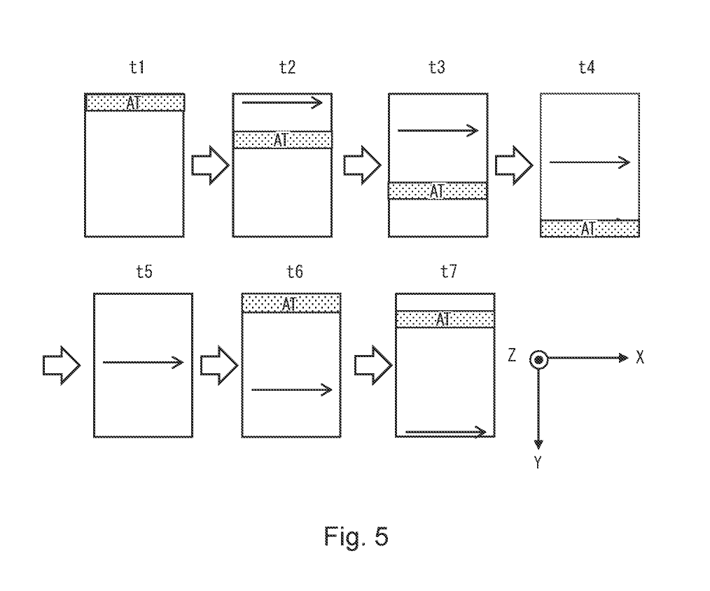

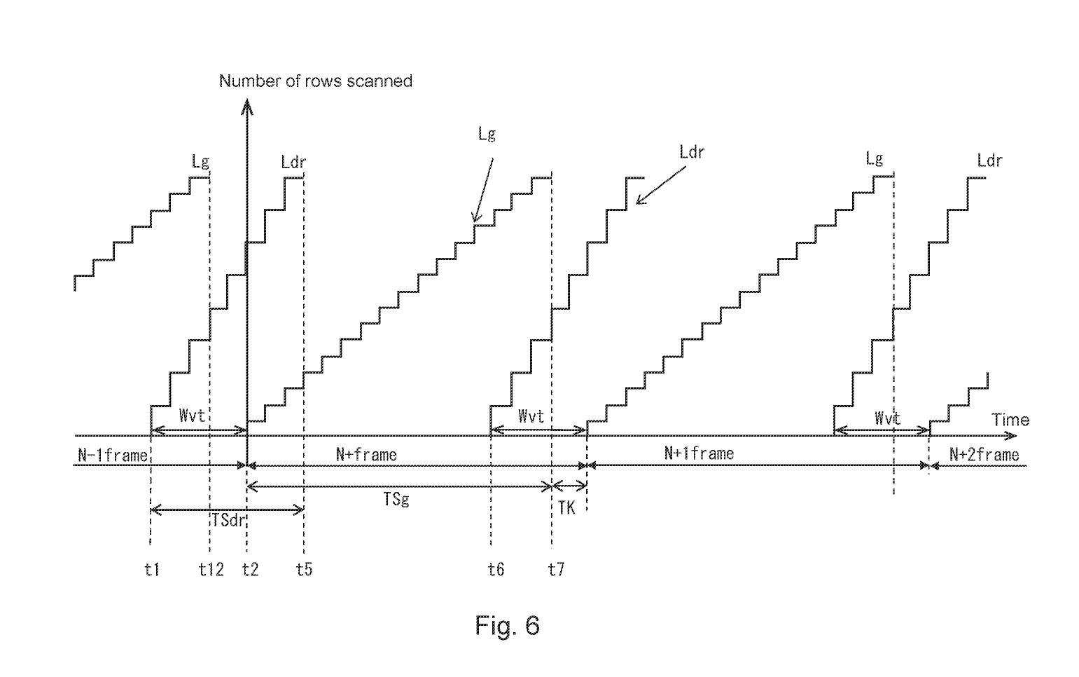

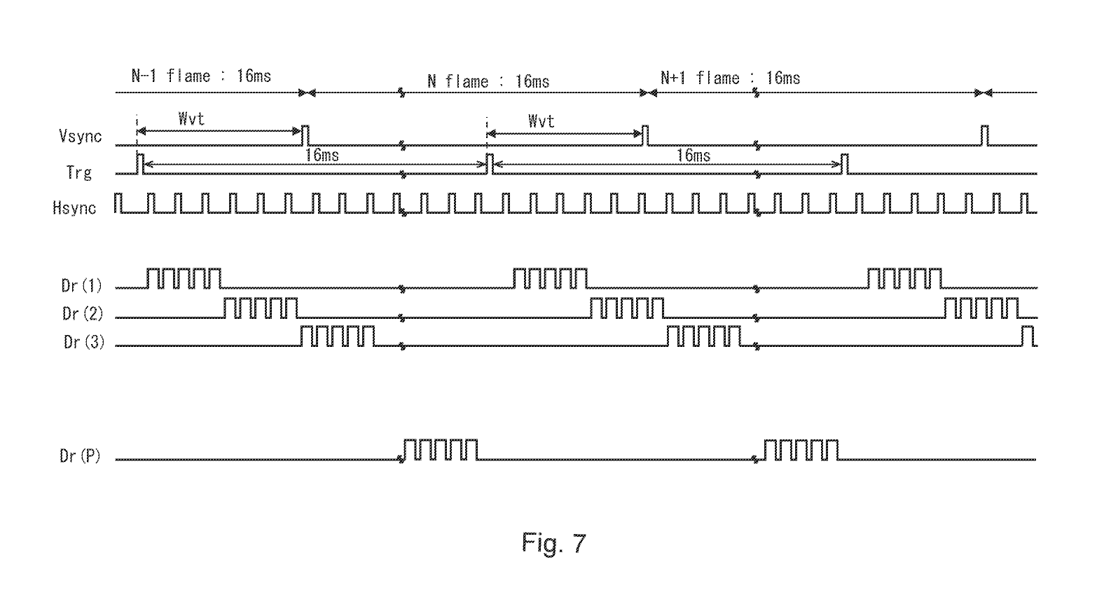

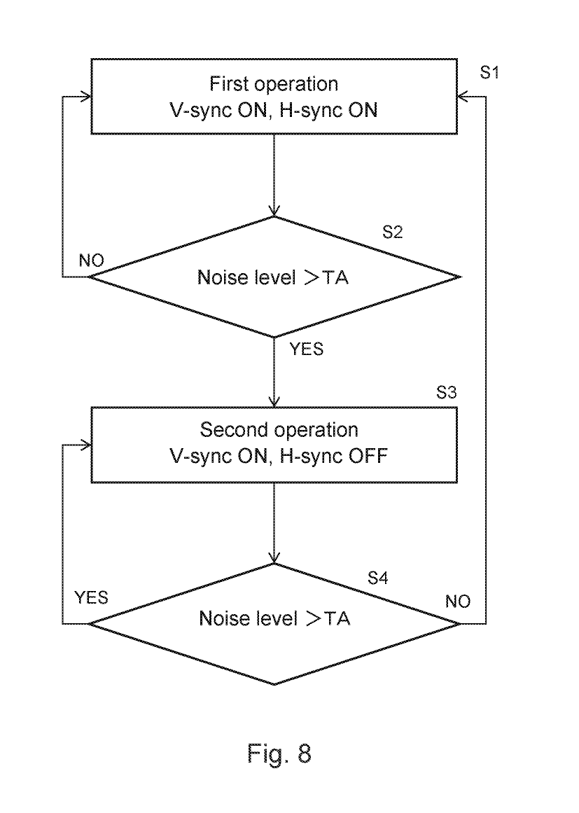

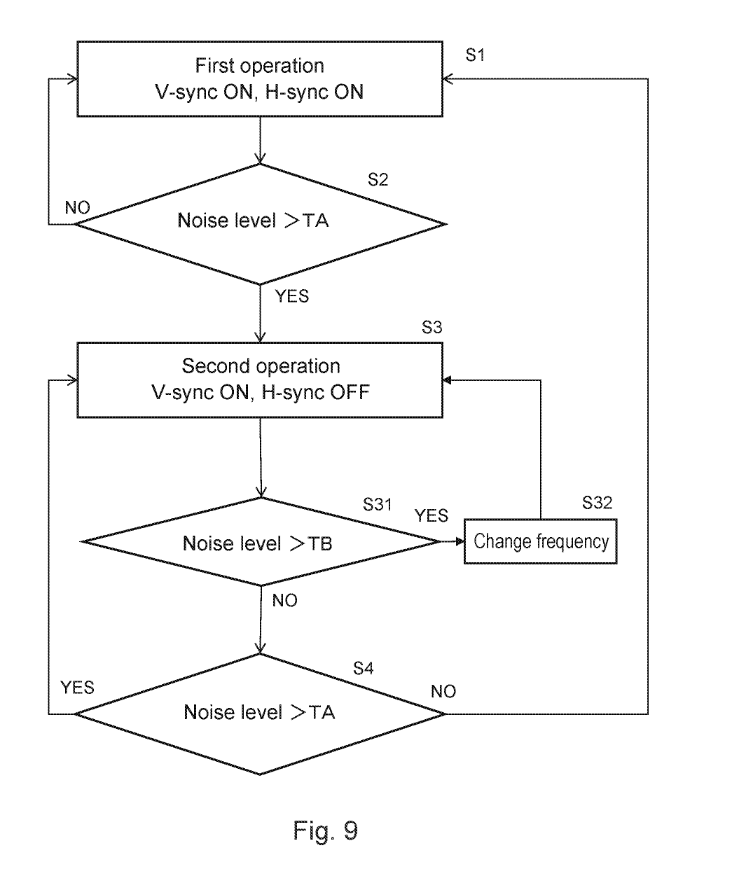

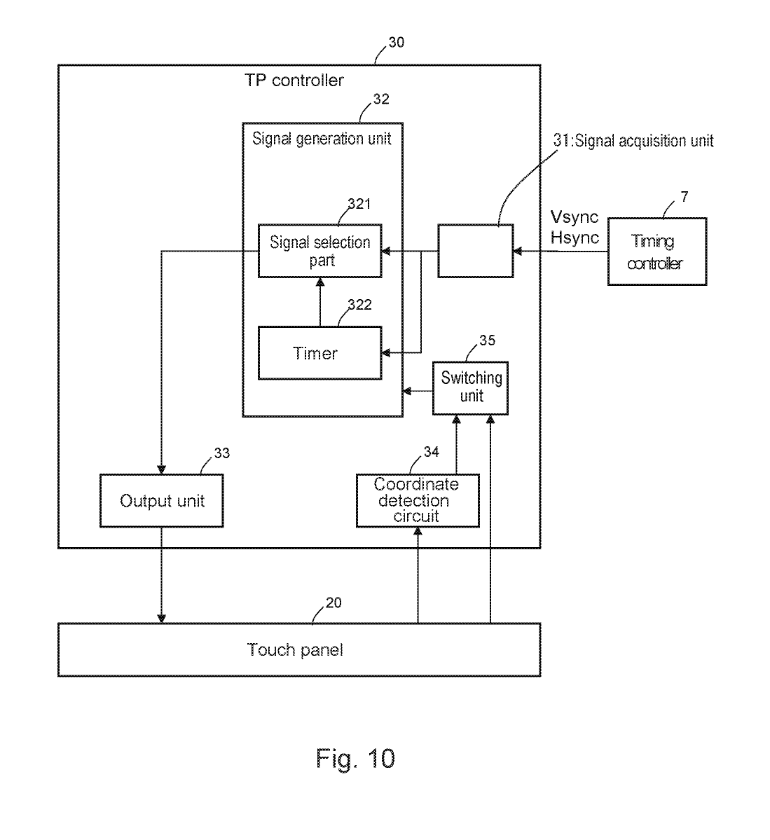

### BRIEF DESCRIPTION OF DRAWINGS

[FIG. 1] FIG. 1 is a block diagram illustrating an exemplary configuration of a sensor-equipped display device.

[FIG. 2] FIG. 2 is a cross-sectional view illustrating the exemplary configuration of the sensor-equipped display device illustrated in FIG. 1.

[FIG. 3] FIG. 3 is a perspective view illustrating an exemplary laminate configuration of drive lines, detection lines, gate lines G, and data lines.

[FIG. 4] FIG. 4 illustrates exemplary waveforms of driving signals of the display device and the detection device.

[FIG. 5] FIG. 5 illustrates exemplary transition of the location where the gate line is driven and the location where the drive line is driven, on the screen.

[FIG. 6] FIG. 6 is a graph for explaining the relationship between the progress of the scanning of the gate lines and that of the drive lines.

[FIG. 7] FIG. 7 illustrates exemplary signal waveforms in a second operation.

[FIG. 8] FIG. 8 is a flowchart illustrating an exemplary process for switching between the first operation and the second operation.

[FIG. 9] FIG. 9 is a flowchart illustrating a modification example of the process for switching between the first operation and the second operation.

[FIG. 10] FIG. 10 is a functional block diagram illustrating an exemplary configuration of a TP controller 30.

### MODE FOR CARRYING OUT THE INVENTION

A sensor-equipped display device in one embodiment of the present invention relates to a sensor-equipped display device that includes a screen that displays an image, and a sensor that detects contact or approach of an object with respect to the screen. The sensor-equipped display device includes: a plurality of display scanning lines that are arrayed in a first direction; a plurality of data lines that are arrayed in a second direction that is different from the first direction; a plurality of switching elements that are provided in correspondence to points of intersection between the display scanning lines and the data lines, respectively; and a plurality of pixel electrodes that are connected to the switching elements, respectively.

Further, the sensor-equipped display device includes: a scanning driving unit that repeats a screen scanning operation with respect to the display scanning lines, the screen scanning operation with respect to the display scanning lines being an operation of selecting the display scanning lines sequentially in the first direction throughout the screen; and a data driving unit that outputs a signal to the data lines in synchronization with the scanning of the display scanning lines by the scanning driving unit, thereby applying, to the pixel electrodes, voltages corresponding to gray levels to be displayed, respectively.

The sensor-equipped display device further includes: a plurality of detection scanning lines that are arrayed in the first direction; a plurality of detection lines that are arrayed in the second direction; and a detection control unit that repeats a screen scanning operation of outputting a driving signal that includes a plurality of pulses, to the detection scanning lines sequentially, and detects signals of the detection lines in correspondence to the driving signal to the detection scanning lines.

The detection control unit is capable of switching a first operation and a second operation from one to the other. The first operation is an operation that controls timings of the screen scanning operation with respect to the detection scanning lines based on timings of the screen scanning operation with respect to the display scanning lines, and controls timings of the pulses of the driving signal based on timings of signal output to the data lines. The second operation is an operation that controls timings of the screen scanning operation with respect to the detection scanning lines based on timings of the screen scanning operation with respect to the display scanning lines, and outputs a driving signal having pulses of a frequency that is different from a frequency of the signal output to the data lines.

According to the above-described configuration, the detection control unit, in any case of the first operation and the second operation, controls timings of the screen scanning operation with respect to the detection scanning lines based on timings of the screen scanning operation with respect to the display scanning lines. This makes it possible to perform the screen scanning operation with respect to the detection scanning lines at timings that do not interfere with the screen scanning operation with respect to the display scanning lines. Besides, in the first operation, timings of the pulses of the driving signal for the detection scanning lines is controlled based on the timings of signal output to the data lines, which makes it possible to drive the detection scanning lines at timings that do not interfere with the signal output to the data lines. This therefore makes it possible to execute the driving of screen display and the driving for detection simultaneously, while suppressing the interference therebetween. This makes it easier to ensure the time for the detection operation. Further, since the above-described configuration is capable of switching the first operation and the second operation from one to the other, the frequency of the pulses of the driving signal for the detection scanning lines can be different from the frequency of the signal output to the data lines. Accordingly, the frequency of the pulses of the driving signal is not restricted by the timings of signal output to the data lines, and can be different from the frequency of the signal output to the data lines depending on noise environments and the like. This makes it possible to suppress influences of the display operation and exogenous noise on the detection operation.

The frequency of the pulses of the driving signal in the second operation can be set higher than the frequency of the pulses of the driving signal in the first operation. This allows the number of pulses per unit time to increase, thereby allowing the noise immunity to improve.

The detection control unit can switch the first operation and the second operation from one to the other based on a level of a noise contained in the signal detected at the detection lines. This makes it possible to appropriately switch the first operation and the second operation based on the state of the noise.

The detection control unit can switch the first operation and the second operation from one to the other based on a level of a noise in a frequency range containing the frequency of the pulses of the driving signal in the first operation. This makes it possible to avoid a noise at a specific high frequency that highly possibly influences the driving signal to the detection scanning lines during the first operation.

The detection control unit can switch the first operation to the second operation, when the noise level in the first operation exceeds a preliminarily set range. In this configuration, the frequency of the pulses can be set to a frequency different from that of exogenous noise when, for example, the frequency of the pulses in the first operation interferes with the exogenous noise.

The detection control unit starts the screen scanning operation with respect to the detection scanning lines, according to a signal generated based on a synchronization signal for controlling the timings of the screen scanning operation with respect to the display scanning lines by the scanning driving unit. This makes it possible to easily control the timings of the screen scanning operation with respect to the detection scanning lines, based on the timings of the screen scanning operation with respect to the display scanning lines.

The detection control unit can control a timing of starting the screen scanning operation with respect to the detection scanning lines, based on a vertical synchronization signal for controlling the timings of the screen scanning operation with respect to the display scanning lines by the scanning driving unit. Further, the detection control unit can control timings of outputting the pulses of the driving signal to the detection scanning lines, respectively, based on a horizontal synchronization signal for controlling the timings of signal output to the data lines.

This makes it easier to control the timings of the screen scanning operation with respect to the detection scanning lines based on the timings of the screen scanning operation with respect to the display scanning lines, and to control the timings of the pulses of the driving signal to the detection scanning lines, respectively, based on the timings of the signal output to the data lines.

The sensor-equipped display device can further include: a first substrate on which the display scanning lines, the data lines, and the switching elements are arranged; a second substrate provided so as to be opposed to the first substrate; and a common electrode provided so as to be opposed to the pixel electrodes. In this case, the detection scanning lines and the detection lines are arranged on at least one of the first substrate and the second substrate, and are provided independently from the common electrode.

By arranging the detection scanning lines and the detection lines for detection on at least one of the first substrate, on which the display scanning lines, the data lines, and the switching elements for display are arranged, and the second substrate opposed to the first substrate, the display unit and the sensor can be formed integrally by using the first substrate and the second substrate. Further, by providing the detection scanning lines and the detection lines independently from the common electrode opposed to the pixel electrodes, the driving of the detection scanning lines and the driving of the display scanning lines hardly restrict each other. This therefore increases the degree of freedom in design for the driving method.

A control device in an embodiment of the present invention controls electronic equipment that includes: a screen having a plurality of pixels arranged in matrix; and a sensor that includes detection scanning lines extending in a row direction of the pixels and detection lines extending in a column direction of the pixels, and detects contact or approach of an object with respect to the screen. The control device includes: a signal acquisition unit, a signal generation unit, and an output unit. The signal acquisition unit receives a vertical synchronization signal for controlling a timing for starting update of display on the screen, and a horizontal synchronization signal for controlling timings for the update of the display of the pixels of the rows on the screen, respectively. The signal generation unit generates a signal for controlling the timings of the screen scanning operation with respect to the detection scanning lines, and a signal that is a base of the driving signal having a plurality of pulses to be output to the detection scanning lines. The output unit outputs the driving signal to the detection scanning lines based on the signal generated by the signal generation unit.

The signal generation unit is capable of switching a first operation and a second operation from one to the other. The first operation is an operation that generates a signal for controlling the timings of the screen scanning operation with respect to the detection scanning lines based on the vertical synchronization signal, and generates a signal for controlling timings of the pulses of the driving signal based on the horizontal synchronization signal. The second operation is an operation that generates a signal for controlling the timings of the screen scanning operation with respect to the detection scanning lines based on the vertical synchronization signal, and generates a signal for generating the pulses of the driving signal at a frequency different from a frequency of the horizontal synchronization signal.

A control method in an embodiment of the present invention relates to a control method for controlling electronic equipment that includes a sensor that detects contact or approach of an object with respect to the screen. The electronic equipment includes a screen having a plurality of pixels arranged in matrix; detection scanning lines extending in a row direction of the pixels; and detection lines extending in a column direction of the pixels. The producing method includes: a signal acquisition step of receiving a vertical synchronization signal for controlling a timing for starting update of display on the screen, and a horizontal synchronization signal for controlling timings for the update of the display of the pixels of the rows on the screen, respectively; a signal generation step of generating a signal for controlling the timings of the screen scanning operation with respect to the detection scanning lines, and a signal that is a base of the driving signal having a plurality of pulses to be output to the detection scanning lines; and an output step of outputting the driving signal to the detection scanning lines based on the signal generated in the signal generation step. In the signal generation step, a first operation and a second operation can be switched from one to the other, wherein the first operation generates a signal for controlling the timings of the screen scanning operation with respect to the detection scanning lines based on the vertical synchronization signal, and generates a signal for controlling timings of the pulses of the driving signal based on the horizontal synchronization signal; and the second operation generates a signal for controlling the timings of the screen scanning operation with respect to the detection scanning lines based on the vertical synchronization signal, and generates a signal for generating the pulses of the driving signal at a frequency different from a frequency of the horizontal synchronization signal.

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of part of constituent members is omitted. Further, the dimension ratios of the constituent members illustrated in the drawings do not necessarily indicate the real dimension ratios.

### Embodiment 1

### (Exemplary Configuration of Sensor-equipped Display Device)

FIG. 1 is a block diagram illustrating an exemplary configuration of a sensor-equipped display device in Embodiment 1. The sensor-equipped display device 1 illustrated in FIG. 1 is electronic equipment that includes a screen that displays an image, and a sensor that detects contact or approach of an object with respect to the screen. The sensor-equipped display device 1 includes a display device 2, a detection device 3, and a system-side controller 10.

### <Exemplary Configuration of Display Device>

The display device 2 has a plurality of gate lines G (G(1), G(2), . . . , G(n), G(N)) and a plurality of data lines S (S(1), S(2), . . . , S(i), S(M)), which are arranged in a display region 2a, which corresponds to the screen that displays an image. The gate lines G are exemplary display scanning lines, and are arrayed in a first direction (the Y direction in the example illustrated in FIG. 1). The data lines S are arrayed in a second direction that is different from the first direction (the X direction that intersects with the Y direction at right angles in the example illustrated in FIG. 1).

At positions corresponding to the points of intersection of the gate lines G and the data lines S, thin film transistors (TFTs) 8 are provided. Each TFT 8 is connected to the gate line G and the data line S. Further, to each TFT 8, a pixel electrode 9 is connected. The TFT 8 is an exemplary switching element. The TFT 8 is switched ON/OFF according to a signal of the gate line G. When the TFT 8 is ON, a signal of the data line S is input to the pixel electrode 9. This causes a voltage corresponding to a gray level to be displayed at the pixel is applied to the pixel electrode 9.

In the display region 2a, one pixel is arranged in an area surrounded by two adjacent gate lines G and two adjacent data lines S. In the display region 2a, a plurality of pixels are arranged in matrix. Each pixel includes the TFT 8 and the pixel electrode 9. The area where the pixels are arranged is the display region 2a, that is, the screen. Further, a common electrode 11 is provided at a position opposed to the plurality of pixel electrodes 9.

The display device 2 further includes a timing controller 7, a scanning line driving circuit (gate driver) 4, a data line driving circuit (source driver) 5, and a common electrode driving circuit 6. The timing controller 7 is connected to the system-side controller 10, the scanning line driving circuit 4, the data line driving circuit 5, and the common electrode driving circuit 6. The scanning line driving circuit 4 is connected to the gate lines G. The data line driving circuit 5 is connected to the data lines S. The common electrode driving circuit 6 is connected to the common electrode 11.

The timing controller 7 receives a video signal (as indicated by arrow A) and a synchronization signal (as indicated by arrow D) from the system-side controller 10. The timing controller 7 outputs a video signal to the data line driving circuit 5 (as indicated by arrow F). Based on a synchronization signal D, to the scanning line driving circuit 4, the data line driving circuit 5, and the common electrode driving circuit 6, the timing controller 7 outputs a signal that serves as a reference signal that these circuits refer to when the circuits operate in synchronization with one another, that is, a signal for controlling an operation timing (as indicated by arrows E, F, B).

The synchronization signal D includes, for example, a vertical synchronization signal and a horizontal synchronization signal. The vertical synchronization signal can be a signal that indicates the timing for scanning the screen, that is, the timing for updating the display on the screen. The horizontal synchronization signal can be a signal that indicates the timing for plotting the pixels in each row on the screen.

As one example, the timing controller 7 outputs a gate startpulse signal and a gate clock signal based on the vertical synchronization signal and the horizontal synchronization signal, to the scanning line driving circuit 4 (as indicated by arrow E). The gate startpulse signal can include, for example, a pulse that is generated at a timing corresponding to a timing at which a pulse of the vertical synchronization signal is generated. The gate clock signal can include a pulse that is generated at a timing corresponding to a timing at which a pulse of the horizontal synchronization signal is generated.

The timing controller 7 outputs a source startpulse signal, a source latch strobe signal, and a source clock signal based on the vertical synchronization signal and the horizontal synchronization signal, to the data line driving circuit 5 (as indicated by arrow F).

The scanning line driving circuit 4 supplies a signal indicating an image to be displayed, to each data line S. The scanning line driving circuit 4 repeats a scanning operation of selecting the gate lines G in one screen sequentially in the first direction (the Y direction), at cycles indicated by the vertical synchronization signal. More specifically, the scanning line driving circuit 4 starts an operation of scanning one screen according to the gate startpulse signal, and applies a selection signal to the gate lines G sequentially according to the gate clock signal.

The operation of scanning one screen may be carried out by the progressive method in which all the gate lines G(1) to G(N) in one screen are sequentially selected, or alternatively, by the interlace method in which the gate lines are selected with a part of the same being skipped, for example, every other gate lines G are selected.

The data line driving circuit 5 outputs a signal based on a video signal to the data lines S, in synchronization with the scanning of the gate lines G by the scanning line driving circuit 4. With this, a voltage according to an image to be displayed can be applied to the pixel electrode 9. More specifically, the data line driving circuit 5 sequentially holds, in a register, a digital video signal indicating a voltage to be applied to each data line, at a timing at which the pulse of the source clock signal is generated. The digital video signal thus held is converted into an analog voltage, at a timing at which the pulse of the source latch strobe signal is generated. The analog voltage thus obtained by conversion is applied to the plurality of data lines S at once, as a video signal for driving.

The common electrode driving circuit 6 applies a predetermined voltage to the common electrode 11, based on the signal received from the timing controller 7 (as indicated by arrow C).

As is described above, at a timing at which the selection signal is applied to each gate line, the video signal for diving is applied to the data line S, and further, a predetermined voltage is applied to the common electrode 11, whereby an image is displayed on the display region 2a, that is, on the screen.

### <Exemplary Configuration of Detection Device>

The detection device 3 is an exemplary sensor that detects contact or approach of an object such as a finger or a pen with respect to the screen of the display device 1. The detection device 3 includes a touch panel 20 and a touch panel controller (hereinafter referred to as a “TP controller”) 30.

The touch panel 20 includes a plurality of drive lines DRL (DRL(1) to DRL(P)) arrayed in the first direction (in the Y direction in the example illustrated in FIG. 1), and a plurality of detection lines SNL (SNL(1) to SNL(Q)) arrayed in the second direction (in the X direction intersecting with the Y direction at right angles in this example). The drive lines DRL are electrodes extending in the second direction (the X direction). The detection lines SNL are electrodes extending in the first direction (the Y direction). The drive lines DRL are exemplary detection scanning lines.

In FIG. 1, for the sake of explanation, the touch panel 20 and the display region 2a of the display device 2 are drawn at positions that do not overlap in the Z direction, but actually, the touch panel 20 is arranged at a position that overlaps the display region 2a of the display device 2 when viewed in the direction vertical to the screen. In other words, the drive lines DRL and the detection lines SNL are arranged so as to be superposed on the screen, which is the display region 2a. Further, the drive lines DRL are arranged so as to be arrayed in the same direction as the direction in which the gate lines G are arrayed (in the Y direction in the present example). The detection lines SNL are arranged so as to be arrayed in the same direction as the direction in which the data lines S are arrayed (in the X direction in the present example).

FIG. 2 is a cross-sectional view illustrating an exemplary configuration of the sensor-equipped display device 1 illustrated in FIG. 1. In the example illustrated in FIG. 2, the sensor-equipped display device 1 includes a first substrate 12 and a second substrate 16 that are opposed to each other. Between the first substrate 12 and the second substrate 16, a liquid crystal layer 14 is provided.

On a surface of the first substrate 12 opposed to the second substrate 16, a common electrode 11 and pixel electrodes 9 are provided. The common electrode 11 is provided at a position opposed to the plurality of pixel electrodes 9, with an insulating layer 13 being interposed therebetween. Further, the gate lines G, the data lines S, and the TFTs 8 are arranged on the first substrate 12, though these are not illustrated.

On a surface of the second substrate 16 opposed to the first substrate 12, a color filter 15 and the drive lines DRL are arranged. On another surface of the second substrate 16, on a side opposite to the first substrate 12 side, the detection lines SNL and a polarizing plate 17 are arranged. In the present example, the display device 2 and the detection device 3 are integrally formed with the first substrate 12 and the second substrate 16. Both of the drive lines DRL and the detection lines SNL are provided independently from the common electrode 11. In other words, the configuration is not such that the common electrode 11 of the display device 2 doubles as the drive lines DRL or the detection lines SNL of the touch panel 20. This makes the driving of the touch panel 20 less restricted by the driving of the display device 2.

The first substrate 12 and the second substrate 16 can be formed with, for example, glass or resin. The pixel electrodes 9, the common electrode 11, the detection lines SNL, and the drive lines DRL can be formed with, for example, transparent electrodes such as electrodes made of indium tin oxide (ITO) or the like.

FIG. 3 is a perspective view illustrating an exemplary laminate structure of the drive lines DRL, the detection lines SNL, the gate lines G, and the data lines S. In the example illustrated in FIG. 3, the layer of the gate lines G, the layer of the data lines S, the layer of the drive lines DRL, and the layer of the detection lines SNL, are laminated in the Z direction. Capacitors are formed between the drive lines DRL and the detection lines SNL. The capacitance at a position corresponding to each point of intersection between the drive lines DRL and the detection lines SNL changes depending on the approach or contact of an object. The matrix formed by the drive lines DRL and the detection lines SNL is arranged so as to overlap the entirety of the display region 2a. This means that the drive lines DRL and the detection lines SNL are arranged in an area overlapping an area where the gate lines G and the data lines S are provided.

In the example illustrated in FIG. 3, the gate lines G and the drive lines DRL are arranged so as to be parallel to each other. The gate lines G and the drive lines DRL do not have to be completely parallel. For example, the direction of the gate lines G and the direction of the drive lines DRL may be slightly different. The drive lines DRL may include some parts that are not parallel with the gate lines G.

To the drive lines DRL, a driving signal is input sequentially. To the detection lines SNL, response signals in response to the driving signal are output as detection signals. The detection signals contain information with regard to capacitances at positions corresponding to the points of intersection between the drive lines DRL and the detection lines SNL.

For example, the TP controller 30 repeats a scanning operation of sequentially applying a driving signal to the drive lines DRL in the first direction (the Y direction), and in response to the driving of the drive lines DRL, detects respective detection signals of the detection lines SNL. The driving signal includes a plurality of pulses. During respective periods while the drive lines DRL are driven, the TP controller 30 detects respective signals of the detection lines SNL. In the detected signals, changes in the capacitances around the drive lines DRL and the detection lines SNL are reflected. In other words, changes in the capacitances in the display region 2a (the screen) are detected as the detection signals of the detection lines SNL. The TP controller 30 is capable of computing the position of contact or approach of an object with respect to the screen, based on the signals detected from the detection lines SNL. The TP controller 30 is an exemplary detection control unit.

The exemplary laminate structure of the gate lines G, the data lines S, the drive lines DRL, and the detection lines SNL is not limited to the example illustrated in FIGS. 2 and 3. For example, the order of lamination of the drive lines DRL and the detection lines SNL may be in the reverse order. Further, the drive lines DRL and the detection lines SNL can be formed in the same layer. Still further, the substrate on which the drive lines DRL and the detection lines SNL are formed is not limited to the second substrate 16, but the drive lines DRL and the detection lines SNL can be arranged on the first substrate 12, or can be arranged dispersedly on both of the first substrate 12 and the second substrate 16.

FIG. 1 is referred to again. The TP controller 30 controls the timings of the screen scanning operation with respect to the drive lines DRL in the touch panel 20, based on a synchronization signal received from the timing controller 7. This allows the timings of the screen scanning operation with respect to the drive lines DRL to be controlled based on the timings of the screen scanning operation with respect to the gate lines G. Besides, this also allows the timings of the pulses of the driving signal to be output to the driving lines DRL to be controlled based on the timings of the signal output to the data lines S.

The TP controller 30 is configured to be capable of switching the first operation and the second operation. In both of the first and second operations, the TP controller 30 controls the timings of the screen scanning operation with respect to the drive lines DRL, based on the timings of the screen scanning operation with respect to the gate lines G. In the first operation, the TP controller 30 controls the timings of the pulses of the driving signal to be output to the driving lines DRL based on the timings of the signal output to the data lines S. In the second operation, the TP controller 30 outputs, to the driving lines DRL, a driving signal having pulses of a frequency that is different from that of the signal output to the data lines S.

The TP controller 30 controls the timings of the screen scanning operation with respect to the drive lines DRL so that, for example, the gate line G and the driving line DRL, driven at the same time, should not overlap each other on the screen. In other words, while the screen scanning operation with respect to the gate lines G and the screen scanning operation with respect to the driving lines DRL are performed simultaneously, the timings of the screen scanning operation with respect to the drive lines DRL is controlled so that the area in which the gate line G is driven and the area in which the driving line DRL is driven should not overlap each other.

The TP controller 30 can, for example, advance/delay the start of the screen scanning operation with respect to the driving lines DRL, from the start of the screen scanning operation with respect to the gate lines G. Besides, the TP controller 30 can appropriately set time for scanning one screen with respect to the drive lines DRL, thereby making it possible to ensure that the position at which the gate line G is scanned and the position at which the driving line DRL is scanned should not overlap each other.

For example, the TP controller 30 can cause the screen scanning operation with respect to the gate lines G to be started between the start and the end of the time for scanning one screen with respect to the driving lines DRL, and can control the time for scanning one screen with respect to the drive lines DRL so that it should be equal to or shorter than the time for scanning one screen with respect to the gate lines G.

Here, “time for scanning one screen” is time necessary for performing a single screen scanning operation. For example, a time required for scanning all of the drive lines DRL or the gate lines G to be scanned in a single screen scanning operation is assumed to be “time for scanning one screen”. On the other hand, a cycle of the screen scanning operation is a period of time from the start of a current one of the screen scanning operation until the start of a next one of the screen scanning operation. The time for scanning one screen, therefore, is not necessarily equal to the cycle of the screen scanning operation.

The TP controller 30 can generate a signal for controlling timings for driving the drive lines DRL, based on a synchronization signal for controlling timings for scanning the gate lines G. For example, based on the timings at which the pulses of the vertical synchronization signal received from the timing controller 7 are generated, the TP controller 30 can generate a signal indicating a timing for starting the screen scanning operation with respect to the drive lines DRL.

As one example, the TP controller 30 can generate a trigger signal that causes a pulse to be generated at a point in time that is advanced/delayed for a certain period of time from the point in time when the pulse of the vertical synchronization signal is generated. The TP controller 30 causes the screen scanning operation with respect to the drive lines DRL at a timing when the pulse of the trigger signal is generated. This allows the screen scanning operation with respect to the drive lines DRL to start at a point in time that is advanced/delayed for a certain period of time from the point in time when the screen scanning operation with respect to the gate lines starts. Or alternatively, in response to the generation of a pulse of the trigger signal, a startpulse signal that causes a pulse to be generated at a predetermined cycle may be generated, so that this is used as a signal that instructs the start of the screen scanning operation with respect to the drive lines DRL. By controlling the start of the screen scanning operation with respect to the drive lines DRL in this way by using the trigger signal that indicates the timing advanced/delayed from the pulse of the vertical synchronization signal, the screen scanning operation with respect to the drive lines DRL can start before the screen scanning operation with respect to the gate lines starts.

A driving signal applied to one drive line DRL can include, for example, a plurality of pulses generated at a predetermined frequency. By controlling the number of such pulses and frequencies thereof, the time for scanning the drive lines DRL in one screen can be controlled. The TP controller 30 can set the number of pulses of the driving signal and the frequency thereof, by using, for example, a value preliminarily recorded in a register (not shown) or the like. Or alternatively, the TP controller 30 can control the frequency of the pulses of the diving signal, by using the synchronization signal used for driving the display device 1.

For example, in the first operation, the TP controller 30 can control the timings of the pulses to be applied to each drive line DRL, based on the horizontal synchronization signal received from the timing controller 7. As a specific example, a signal that has pulses that are generated at the same cycle as the cycle at which the pulses of the horizontal synchronization signal are generated, and that is generated at timings advanced/delayed for a certain period of time from the timings at which the pulses of the horizontal synchronization signal are generated, can be used as a driving signal for each drive line DRL. This makes it possible to drive the drive lines DRL at timings advanced/delayed from the timings of the signal output to the data lines S. In other words, at a timing that does not interfere with the signal output to the data lines S, the detection scanning lines can be driven.

In the second operation, the TP controller 30 can output, to the driving lines DRL, a driving signal having pulses that are generated at a frequency that is different from the frequency of the horizontal synchronization signal. The frequency of the pulses can be determined by using, for example, a value that is preliminarily recoded in a register or the like.

### <Exemplary Operation of Detection Device>

In the detection device 3, the TP controller 30 is capable of switching the first operation and the second operation from one to the other. The first operation is an operation of controlling the timings of the screen scanning operation with respect to the drive lines DRL based on the timings of the screen scanning operation with respect to the gate lines G, and controlling the timings of the pulses of the driving signal to be output to each of the driving lines DRL based on the timings of the signal output to the data lines S. The second operation is an operation of controlling the timings of the screen scanning operation with respect to the drive lines DRL based on the timings of the screen scanning operation with respect to the gate lines G, and outputting, to the driving lines DRL, a driving signal having pulses of a frequency that is different from the frequency of the signal output to the data lines S.

### (Exemplary First Operation)

FIG. 4 illustrates exemplary waveforms of signals in the first operation. In the example illustrated in FIG. 4, the timing for driving the display device 2 is controlled according to a vertical synchronization signal Vsync and a horizontal synchronization signal Hsync in which pulses are generated at a certain set cycle.

The pulse interval of the vertical synchronization signal Vsync is one frame period. During one frame period, the gate lines G in one screen are scanned. For example, the pulse of the vertical synchronization signal Vsync serves as a trigger for the start of the screen scanning operation with respect to the gate lines G. The horizontal synchronization signal Hsync controls the timing for writing with respect to the pixels in each row. For example, at a timing when a pulse of the horizontal synchronization signal Hsync is generated, the selection signal is applied to one of the gate lines G, and video signals are applied to a plurality of the data lines S at once.

The TP controller 30 can grasp the timing at which the screen scanning operation with respect to the gate lines G starts, with use of the vertical synchronization signal Vsync. Further, the TP controller 30 can grasp the timing at which each gate line is selected and signals are input to the data lines S, that is, the writing timing, with use of the horizontal synchronization signal Hsync. The TP controller 30 can receive the vertical synchronization signal Vsync and the horizontal synchronization signal Hsync, for example, from the timing controller 7 or the system-side controller 10.

The trigger signal Trg is a signal generated by the TP controller 30 based on the vertical synchronization signal Vsync and the horizontal synchronization signal Hsync. The trigger signal Trg controls the timing for starting the screen scanning operation with respect to the drive lines DRL of the touch panel.

In the example illustrated in FIG. 4, the cycle (frequency) of the pulses of the trigger signal Trg is identical to that of the vertical synchronization signal Vsync (16 ms). The pulses of the trigger signal Trg are generated at timings advanced for a certain period (Wvt) from the pulses of the vertical synchronization signal Vsync. The TP controller 30 can preliminarily set the period Wvt between the pulse of this trigger signal Trg and the generation of the pulse of the vertical synchronization signal Vsync (that is, a width for adjustment between Vsync and Trg).

The TP controller 30, when detecting a pulse of the trigger signal Trg, starts the screen scanning operation with respect to the driving lines DRL. Each of the driving signals Dr for the driving lines DRL has a plurality of pulses that are in synchronization with the horizontal synchronization signal Hsync. In other words, the driving signal Dr includes a pulse that is generated when a certain period (Wht) elapses after a pulse of the horizontal synchronization signal Hsync. Thereby, the driving signal Dr having pulses of the same frequency as that of the signal output to the data lines S is output. The frequency of the pulses of the driving signal Dr is, in this example, equal to that of the horizontal synchronization signal Hsync, but it may be a frequency of an integer multiple of the frequency of the horizontal synchronization signal Hsync. The TP controller 30 is capable of controlling the time difference (Wht) between a pulse of the driving signal Dr, and a pulse of the horizontal synchronization signal Hsync. Further, the TP controller 30 is also capable of controlling the number of pulses of the driving signal Dr to be applied to one driving line DRL.

The driving signals Dr(1) to Dr(P) (hereinafter, these are collectively referred to as “driving signal Dr” when they are not distinguished particularly) are applied sequentially to the drive lines DRL(1) to DRL(P), i.e., all of the drive lines in the screen, respectively, and then, the operation for scanning one screen ends. Here, time for scanning one screen with respect to the drive lines DRL(1) to DRL(P) is controlled by the TP controller 30 so as to be shorter than time for scanning one screen with respect to the gate lines G(1) to G(N). The TP controller 30 can control the time for scanning one screen with respect to the drive lines DRL(1) to DRL(P) by, for example, controlling the number of pulses of the driving signal applied to each drive line DRL, the frequency of the same, or the like.

In the present embodiment, as one example, the time for scanning one screen with respect to the drive lines DRL(1) to DRL(P) can be equal to, or less than, half of the time for scanning one screen with respect to the gate lines G(1) to G(N). This makes it possible to ensure sufficient time between a current one of the screen scanning operation with respect to the drive lines DRL(1) to DRL(P), and the next one of the screen scanning operation with respect to the drive lines DRL(1) to DRL(P). This makes it possible to ensure sufficient time for a detection signal processing operation (for example, computing a detection position using a detection signal) by the TP controller 30.

As described above, the start of the screen scanning operation with respect to the gate lines G in the display device 2, that is, the start of writing to the screen, and the start of the screen scanning operation in the touch panel 20, do not coincide with each other, whereby a location where the writing to the screen in the display device 2 is performed, and a portion of the touch panel 20 that is driven, can be made different. This makes it possible to suppress the mutual interference.

FIG. 5 illustrates exemplary transition of the location where the gate line G is driven and the location where the drive line DRL is driven, on the screen. FIG. 5 illustrates an exemplary case where the display device 2 and the touch panel 20 are driven with the signals illustrated in FIG. 4. In FIG. 5, the rectangle indicates the screen, the arrow indicates the location in the screen where the gate line G is driven, that is, a location where the writing of an image is performed, and the dot pattern indicates the location (AT) where the drive line DRL is driven.

In the example illustrated in FIG. 5, at time t1, at the point in time when the screen scanning operation with respect to the drive lines DRL starts, the screen scanning operation with respect to the gate lines G has not started yet. After the start of the screen scanning operation with respect to the drive lines DRL, as the scanning is going on, the location where the drive line DRL is driven moves in the downward direction on the screen (in the positive direction in the Y direction). At time t2 when the screen scanning operation with respect to the gate lines G starts, the location where the drive line DRL is driven is lower than the location where the gate line G is driven. In other words, at time t2, the driven location in the screen scanning operation with respect to the drive lines DRL is different from the driven location in the screen scanning operation with respect to the gate lines G.

The screen scanning rate in the Y direction with respect to the drive lines DRL is higher than the scanning rate with respect to the gate lines G. Therefore, during a period from time t2 to time t5 while the location where the drive line DRL is driven shifts and reaches the lower end of the screen, whereby the screen scanning operation with respect to the drive lines DRL ends (time t2 to time t5), the location where the gate line G is driven never catches up with the location where the drive line DRL is driven. In other words, before a current one of the screen scanning operation with respect to the gate lines G ends, a current one of the screen scanning operation with respect to the drive lines DRL ends, and a next one of the screen scanning operation with respect to the drive lines DRL starts (time t6). When the screen scanning operation with respect to the gate lines G ends (time t7), the next one of the screen scanning operation with respect to the drive lines DRL has started already.

In this way, during a period while the screen scanning operation with respect to the gate lines G and the screen scanning operation with respect to the drive lines DRL are performed simultaneously, the display device 2 and the touch panel 20 are controlled in such a manner that the location where the gate line G is driven and the location where the drive line DRL is driven should not overlap. This makes it possible to suppress the mutual interference.

FIG. 6 is a graph for explaining the relationship between the progress of the scanning of the gate lines G and that of the drive lines DRL. In the graph of FIG. 6, the vertical axis represents the number of rows of pixels scanned (the number of lines), and the horizontal axis represents time. FIG. 6 illustrates an exemplary case where the display device 2 and the touch panel 20 are driven with the signals illustrated in FIG. 4. In FIG. 6, the line Ldr indicates the degree of progress of the screen scanning operation with respect to the drive lines DRL in the Y direction, and the line Lg indicates the degree of progress of the screen scanning operation with respect to the gate lines G in the Y direction. The degree of progress of the scanning operation is indicated by the number of rows of the pixels.

As illustrated in FIG. 6, at time t1, the screen scanning operation with respect to the drive lines DRL starts a period Wvt earlier than the start (time t2) of the screen scanning operation with respect to the gate lines G. Then, the screen scanning operation with respect to the drive lines DRL ends after the screen scanning operation with respect to the gate lines G starts and before the same ends (time t5). Further, the time t1 when the screen scanning operation with respect to the drive lines DRL starts is before the time t2 when the screen scanning operation with respect to the gate lines G starts, and before the time t12 when a preceding one of the screen scanning operation with respect to the gate lines G ends.

In this way, in the present example, the screen scanning operation with respect to the drive lines DRL is performed, extending over two consecutive periods of the screen scanning operations with respect to the gate lines G. More specifically, the screen scanning operation with respect to the drive lines DRL starts before the former one of the two consecutive screen scanning operations with respect to the gate lines G ends, and the screen scanning operation with respect to the drive lines DRL ends after the latter screen scanning operation with respect to the gate lines G starts.

Here, time TSdr required for scanning the drive lines DRL over all of rows of the pixels in the screen is shorter than time TSg required for scanning the gate lines G over all of rows of the pixels in the screen. In other words, the scanning rate in the Y direction with respect to the drive lines DRL is higher than the writing rate in the Y direction with respect to the gate lines G. The lines Ldr, therefore, never cross with the lines Lg. The drive line DRL and the gate line G corresponding to the same row are never driven at the same time.

In the example illustrated in FIG. 6, the cycle of the screen scanning operation with respect to the drive lines DRL is the same as the cycle of the screen scanning operation with respect to the gate lines G. In both of the screen scanning operations, one frame period is the cycle thereof. This makes it possible to further surely suppress the interference between the driving of the drive lines DRL and the driving of the gate lines G. The cycle of the screen scanning operation with respect to the drive lines DRL and the cycle of the screen scanning operation with respect to the gate lines G do not have to be the same. For example, the cycle of the screen scanning operation with respect to the drive lines DRL may be shorter than the cycle of the screen scanning operation with respect to the gate lines G, whereby the response performance of the detection can be enhanced.

In the example illustrated in FIG. 6, a period while the scanning of the gate lines G is performed, and a pausing period while the gate lines G and the data lines S are not driven (vertical flyback period), are included in one frame period. In the present example, since the driving of the gate lines G and the driving of the drive lines DRL can be simultaneously carried out, the period for the driving of the drive lines DRL is not limited to the pausing period. In one frame period, therefore, a long period can be ensured for the screen scanning operation with respect to the gate lines G, that is, the pixel writing operation, while the pausing period can be shortened. Or alternatively, the entirety of one frame period may be assigned to the scanning period of the gate lines G, that is, the writing period, so that no pausing period is provided. This makes it possible to easily achieve both of the display image of higher resolution and the improvement of the detection performance, while suppressing the interference.

### (Exemplary Second Operation)

FIG. 7 illustrates exemplar signal waveforms in a second operation. In the example illustrated in FIG. 7, the cycle (frequency) of the pulses of the driving signals Dr(1) to Dr(P) output to the driving lines DRL(1) to DRL(P) is different from that of the example illustrated in FIG. 4. In the example illustrated in FIG. 7, the frequency of the pulses of the driving signal Dr is different from the frequency of the pulses of the horizontal synchronization signal Hsync. The frequency of the pulses of the driving signal Dr therefore is different from the frequency of the signal output to the data lines S. In other words, the driving signal Dr has pulses that are generated at timings independent from the horizontal synchronization signal Hsync. The timings of the pulses of the driving signal Dr are not in synchronization with the horizontal synchronization signal Hsync.

In this way, in the second operation, the frequency of the pulses of the driving signal Dr is not rate-controlled according to the horizontal synchronization signal Hsync. In the second operation, therefore, the TP controller 30 can make the frequency of the pulses of the driving signal Dr different from that of the horizontal synchronization signal Hsync. With this configuration, even in a case, for example, an exogenous noise having a frequency close to the frequency of the horizontal synchronization signal Hsync exists, the driving lines DRL can be driven at a frequency different from the frequency of the exogenous noise. Here, the exogenous noise is a noise other than noises caused by the signals of the data lines S and the gate lines G of the display device 2. A cause of the exogenous noise can be, for example, an electronic component such as a CPU or a power source, or a line, arranged near the touch panel 20.

In the example illustrated in FIG. 7, the frequency of the pulses of the driving signal Dr is higher than the frequency of the horizontal synchronization signal Hsync. In other words, the cycle of the pulses of the driving signal Dr is shorter than the cycle by which each gate line is selected in the screen scanning operation with respect to the gate lines G. The frequency of the pulses of the driving signal Dr in the second operation, therefore, is higher than the frequency of the pulses of the driving signal Dr in the first operation. This makes it possible to improve the noise immunity.

Every time when a pulse of the driving signal Dr is generated, the TP controller 30 detects a signals of the detection line SNL, in response to the pulse. The driving signal Dr includes a plurality of pulses. Accordingly, when the diving signal Dr is output to one driving line DRL, a plurality of detection values, the number of the same corresponding to the number of the pulses, are obtained though the detection lines SNL. These detection values, for example, are integrated, and are used in computation for determining a position of an object to be detected, and the like. In other words, a sum of a plurality of detection values is calculated, and is used in the computation. As the number of the pulses of the driving signal Dr for one driving line DRL is greater, the number of integration times is greater. As the number of integration times is greater, influences of a noise reflected on the detection value determined by integration decrease. For this reason, as the number of the pulses of each of the driving signals Dr for the driving lines DRL is greater, the noise immunity improves.

In the second operation, the pulses of the driving signal Dr are generated at the frequency different from that of the horizontal synchronization signal Hsync, which causes the driving signal Dr to interfere with the signals of the data lines S. It is, therefore, likely that the second operation is influenced by the noises of the signals of the data lines S. To cope with this, the frequency of the pulses of the driving signal Dr is set higher than that in the first operation, which enables to improve the noise immunity. In other words, in the second operation, by increasing the number of the pulses of the driving signal Dr as compared with the first operation, the number of the detection values is increased, whereby the number of times of the computation with respect to the detection values of the TP controller 30 is increased. This makes it possible to apply noise filtering to the detected values.

In the example illustrated in FIG. 7, the screen scanning operation with respect to the driving lines DRL is started at a start timing that is advanced/delayed for a certain period of time (Wvt) from the vertical synchronization signal Vsync, as is the case with the example in FIG. 4. In other words, in the second operation illustrated in FIG. 7, and in the first operation illustrated in FIG. 4 as well, the timing of the screen scanning operation with respect to the drive lines DRL is in synchronization with the timing of the screen scanning operation with respect to the gate lines G (the perpendicular synchronization is ON). It should be noted that in the first operation illustrated in FIG. 4, pulses of each of the driving signals Dr for the driving lines DRL are in synchronization with the timings of the signal output to the data lines S (the horizontal synchronization is ON). In contrast, in the second operation illustrated in FIG. 7, pulses of each of the driving signals Dr for the driving lines DRL are not in synchronization with the timings of the signal output to the data lines S (the horizontal synchronization is OFF).

In this way, in the first operation, since the perpendicular synchronization and the horizontal synchronization are ON, the interference between the display device 2 and the detection device 3, which are driven simultaneously, is suppressed. But, for example, in a case where the diving frequency of the display device 2 and the cycle of exogenous noise interfere with the cycle of the horizontal synchronization signal Hsync, i.e., the cycle of 1 H (one horizontal synchronization period), the detection device 3 performing the first operation is liable to malfunction due to influences of the noise. This is because, in the first operation, the driving signal Dr, which is in synchronization with the horizontal synchronization signal Hsync, is used. In such a case, the TP controller 30 is capable of switching the first operation to the second operation from one to the other. With this, the state in which the horizontal synchronization is ON is switched to the state in which the horizontal synchronization is OFF. In the state in which the horizontal synchronization is OFF, the frequency of the driving signal Dr is different from the frequency of the horizontal synchronization signal Hsync. As a result, the detection device 3 is hardly influenced by an exogenous noise having a cycle that interferes with 1 H.

In the second operation as well, as the state in which the perpendicular synchronization is ON remains, the interference between the driving of the gate lines G and the diving of the driving lines DRL is suppressed. Accordingly, the interference between the display device 2 and the detection device 3 is suppressed. For example, the deterioration of the display quality, such as noises caused by the driving of the detection device 3 being displayed on the display screen, can be suppressed.

(Exemplary process for switching between first operation and second operation)

FIG. 8 is a flowchart illustrating an exemplary process performed by the TP controller 30 for switching between the first operation and the second operation. As illustrated in FIG. 8, in the first operation, the TP controller 30 operates in a state in which the perpendicular synchronization is ON and the horizontal synchronization is ON (S1). In the first operation, the TP controller 30 determines whether or not the level of a noise contained in a signal detected from the detection line SNL exceeds a range that is preliminarily set (S2). Here, it is determined whether or not the noise level exceeds the threshold value TA. The noise level can be determined based on the signal detected from the detection line SNL (hereinafter this signal is referred to as a “response signal”). For example, the noise level can be determined according to whether or not the value of the capacitance obtained from the response signal falls in a preliminarily set allowable range, or according to an extent to which the value of the capacitance is departed from the allowable range.

As an example, the TP controller 30 can determine that the noise level exceeds the threshold value TA in a case where, for example, the distribution of the value of the capacitance obtained from the response signal does not fall in the preliminarily set allowable range. Examples of the case where it does not fall in the allowable range include a case where a capacitance change exceeding the predetermined value is observed at the points of intersection of a certain detection line SNL with all of the drive electrode DRL. Further, for example, a state that cannot occur in a normal touch operation (a state in which a bar-like object is placed so as to cross the screen, etc.) can be determined as a case out of the allowable range.

In this way, the determination whether or not the noise level exceeds the preliminarily set range can include the determination whether or not an abnormality is detected in the response signal. Further, the determination at S2 may include, in addition to the determination in the above-described example, a determination whether or not a noise component contained in the response signal exceeds the predetermined level. Or alternatively, the TP controller 30 can determine, as the determination at S2, the level of the noise component in a predetermined frequency band contained in the response signal. For example, the TP controller 30 can determine the level of a noise component in a frequency band containing the frequency of the horizontal synchronization signal Hsync. This makes it possible to determine the noise level in the frequency band containing the frequency of the pulses of the driving signal Dr in the first operation.

Incidentally, the determination of the noise level is not limited to the determination of the noise level contained in the response signal. The TP controller may be able to determine, for example, the noise level measured by a noise measuring unit provided in the detection device 3. For example, the TP controller may be able to determine a noise level in the frequency band containing the frequency of the pulses of the driving signal Dr, which is detected by a noise measuring unit.

In a case where a noise level exceeds a preliminarily set threshold value TA (S3: YES), the TP controller 30 switches first operation to the second operation (S3). In the second operation, the TP controller 30 operates in a state in which the perpendicular synchronization is ON and the horizontal synchronization is OFF. In a case where the noise level does not exceed the preliminarily set threshold value TA (S3: NO), the TP controller 30 maintains the first operation (S1).

As long as it is determined that the noise level exceeds the threshold value TA (S4: YES), the second operation is continued. In a case where it is determined in the second operation that the noise level does not exceed the preliminarily set threshold value TA (S4: NO), the TP controller 30 switches the second operation to the first operation (S1).

The determination of the noise level at S4 is performed in the same manner as in S2. The threshold value TA used in the determination of the noise level at S4 may be different from the threshold value TA at S2.

### Modification example of process for switching between first operation and second operation

FIG. 9 is a flowchart illustrating a modification example of the process for switching between the first operation and the second operation. In the example illustrated in FIG. 9, Steps S1 and S2 can be executed in the same manner as that in the case illustrated in FIG. 8. In the second operation (S3), in a case where the noise level exceeds the preliminarily set threshold value TB (S31: YES), the TP controller 30 changes the frequency of the pulses of the driving signal Dr (S32). The threshold value TB can be set to, for example, a level higher than the threshold value TA.

The change of the frequency at Step S32 is executed by, for example, the TP controller 30 selecting any one of a plurality of preliminarily set frequencies. The change of the frequency is repeated until the noise level becomes lower than the threshold value TB. The TP controller 30 is thus capable of changing the frequency of the pulses to an appropriate frequency so that the noise level can be lowered. The determination at S31 may be determination whether or not the noise level has become lower than the noise level obtained in the previous determination. Further, for example, the technique of frequency hopping (FH) can be used in the change of the frequency at Step S32.

Instead of the change of the frequency at Step S32, the number of pulses may be changed. More specifically, the TP controller 30 can increase the number of pulses, in a case where the noise level exceeds a preliminarily set range. With an increase in the number of pulses, the number of times of the computation of the detection value by the TP controller 30 increases. This allows the noise immunity to improve.

In this way, in the second operation, the TP controller 30 (the detection control unit) can change the frequency or the number of the pulses of the driving signal, according to the noise level. This allows the noise immunity in the second operation to improve. <Exemplary configuration of TP controller>

The following description describes an exemplary configuration of the TP controller 30 that controls the touch panel 20 so as to realize the above-described operation. FIG. 10 is a functional block diagram illustrating an exemplary configuration of the TP controller 30.

In the example illustrated in FIG. 10, the TP controller 30 includes a signal acquisition unit 31, a signal generation unit 32, an output unit 33, a switching unit 35, and a coordinate detection circuit 34. The signal generation unit 32 includes a signal selection part 321 and a timer 322.

The signal acquisition unit 31 receives a synchronization signal used for controlling the timing for updating the display of the screen, from the timing controller 7. The signal acquisition unit 31 includes, for example, a port for inputting a signal. The synchronization signal includes, for example, the vertical synchronization signal Vsync and the horizontal synchronization signal Hsync.

The signal generation unit 32 generates a signal for controlling the timing of the screen scanning operation with respect to the drive lines DRL, and a signal that is a base of the driving signal Dr having a plurality of pulses, based on the synchronization signal received by the signal acquisition unit 31.

The signal generation unit 32 operates, by switching the first operation and the second operation from one to the other. In the first operation, the signal generation unit 32 generates a signal for controlling the timing of the screen scanning operation with respect to the drive lines DRL, based on the vertical synchronization signal Vsync, and generates a signal for controlling the timings of the pulses of the driving signal Dr based on the horizontal synchronization signal Hsync. In the second operation, the signal generation unit 32 generates a signal for controlling the timing of the screen scanning operation with respect to the drive lines DRL based on the vertical synchronization signal Vsync, and generates a signal for generating the pulses of the driving signal Dr at a frequency different from that of the horizontal synchronization signal Hsync.

In the first operation and the second operation, the signal generation unit 32 generates a signal for such control that during a period from the start of the detection scanning operation with respect to the screen until the end of the same, the updating of the display on the screen starts, as the signal for controlling the timing of the screen scanning operation with respect to the drive lines DRL. Further, the signal generation unit 32 can generate a signal for such control that a scanning time for one screen of the screen scanning operation with respect to the drive lines DRL is equal to, or shorter than, an update time for display of one screen.

The output unit 33 outputs a signal generated by the signal generation unit 32 or a driving signal based on this signal, to the touch panel 20. The output unit 33 applies a driving signal to each drive line DRL, according to the signal generated by the signal generation unit 32.

The coordinate detection circuit 34 calculates coordinates indicating a position on the screen that an object is in contact with or approaches (a position on the touch panel 20), based on a detection signal detected by the detection lines SNL of the touch panel 20.

The switching unit 35 controls the switching by the signal generation unit 32 between the first operation and the second operation. The switching unit 35 determines the noise level contained in the detection signal, based on the detection signals detected at the detection lines SNL of the touch panel 20 or the coordinates computed by the coordinate detection circuit. The first operation and the second operation of the signal generation unit 32 are switched from one to the other, based on the noise level. The switching between the first operation and the second operation based on the noise level can be executed, for example, as illustrated in FIG. 8 or FIG. 9.

In the signal generation unit 32, the timer 322 generates an internal signal, based on the synchronization signal received by the signal acquisition unit 31, and outputs the internal signal to the signal selection part 321. The signal selection part 321 selects at least one signal from the internal generation signal generated by the timer 322 and the synchronization signal received by the signal acquisition unit 31, and transmits the selected signal to the output unit 33.

The timer 322 can generate a pulse when a preliminarily set period of time elapses from the rising or the falling of the pulse of the input signal. This makes it possible to generate, for example, a signal that includes a pulse at a point in time that is advanced/delayed for a certain period of time (for example, Wvt, Wht in FIG. 1, FIG. 8, or the like) from the pulse of the vertical synchronization signal Vsync. Further, a signal can be generated that has pulses generated at a predetermined cycle, for example, like the cycle of the pulses of Trg or Dr(1) to Dr(p) illustrated in FIG. 1, FIG. 8.

For this configuration, the timer 322 can include an edge detection circuit that detects an edge (a rising edge or a falling edge) of a pulse of an input signal, a clock generation circuit that generates a clock signal having a certain frequency, a counter that counts the number of clock pulses of a clock signal after the edge detection, and an internal signal generation circuit that generates a pulse according to the count by the counter (all are not illustrated).

The internal signal generation circuit compares the count of the counter with a value preliminarily set in a register or the like, and when the count reaches the preliminarily set value, the internal signal generation circuit generates a pulse. In this case, Wvt, Wht in FIG. 1, FIG. 8, or alternatively, pulse cycles of Trg or Trg or Dr(1) to Dr(p), or the like can be set preliminarily.

The timer 322 can generate, as an internal signal, for example, the trigger signal Trg, a pulse signal as a base for the driving signals Dr(1) to Dr(P), which are illustrated in FIG. 1, FIG. 8, or a driving synchronization signal for controlling a time for driving one drive line DRL, or the like. The timer 322 generates a pulse that rises a certain period of time (Wht) after the rising of a pulse of the horizontal synchronization signal Hsync, as a pulse of the driving signal Dr signal in the first operation. Further, the timer 322 generates a pulse that rises at a preliminarily set frequency, as a pulse signal of the driving signal Dr in the second operation.

The signal selection part 321 selects at least one signal to be supplied to the output unit 33, from the signals generated by the timer 322. For example, the signal selection part 321 can select the driving signals Dr(1) to Dr(p) for the respective drive lines DRL, which are generated by the timer 322. Or alternatively, the signal selection part 321 can select the pulse signal as a base for the driving signals Dr(1) to Dr(p), and the trigger signal Trg indicating the driving timing. Further, the signal selection part 321 may select the driving synchronization signal, which indicates the driving timing of each drive line DRL. The output unit 33 applies a driving signal Dr to the drive lines DRL(1) to DRL(P), according to the signal output from the signal selection part 321.

When receiving an instruction for the first operation from the switching unit 35, the signal selection unit 321 selects the pulse signal of the driving signal Dr in the first operation, out of the pulse signals generated by the timer. When receiving an instruction for the second operation from the switching unit 35, the signal selection unit 321 selects the pulse of the driving signal Dr in the second operation.

In this way, the configuration can be made such that the timer 322 generates the pulse signal for the first operation and the pulse signal for the second operation, and the signal selection unit 321 selects any one of these based on the instruction from the switching unit 35. The configuration for the switching, however, is not limited to the configuration of the above-described example. For example, the configuration may be such that the timer 322 switches the pulse signal to be generated, based on the instruction from the switching unit 35.

The configuration of the TP controller 30 is not limited to the example illustrated in FIG. 10. For example, the coordinate detection circuit 34 can be arranged outside the TP controller 30. Further, the signal received by the signal acquisition unit 31 is not limited to the vertical synchronization signal Vsync and the horizontal synchronization signal Hsync; in place of these signals, or in addition to these signals, the signal acquisition unit 31 may receive another signal for controlling the update timing of the display screen. For example, the signal acquisition unit 31 can receive a general-purpose input/output (GPIO) from the timing controller 7. Still further, the signal acquisition unit 31 may receive a synchronization signal, not from the timing controller 7, but from the system-side controller 10.

The embodiments of the present invention are described above, but the present invention is not limited to the above-described embodiments.

In the example illustrated in FIG. 4, the cycle of the screen scanning operation with respect to the driving lines DRL is the same as the cycle of the screen scanning operation with respect to the gate lines G, but the cycle of the screen scanning operation with respect to the driving lines DRL may be different from the cycle of the screen scanning operation with respect to the gate lines G. For example, in the example illustrated in FIG. 4, the cycle of the pulses of the trigger signal Trg can be half of the cycle of the pulses of the vertical synchronization signal Vsync.

Further, the embodiments are described with reference to an exemplary driving operation in which a pulse signal is input to each of the drive lines DRL sequentially one by one, but the driving operation may be such that a pulse signal is input simultaneously to two or more of the drive lines DRL. Further, the above-described embodiments are examples of a mutual capacitance touch panel, but the touch panel may be a self-capacitance touch panel.

Further, the display device 2 is not limited to the liquid crystal display device as described above. The display device 2 may be, for example, an organic EL display, a plasma display, or a display in which electrophoresis or MEMS is used.

### DESCRIPTION OF REFERENCE NUMERALS

1: sensor-equipped display device
2: display device
3: detection device
4: scanning line driving circuit (exemplary scanning driving unit)
5: data line driving circuit (exemplary data driving unit)
8: TFT (exemplary switching element)
9: pixel electrode
11: common electrode
20: touch panel
30: TP controller (exemplary detection control unit)
G: gate line (exemplary display scanning line)
S: data line
DRL: drive line (exemplary detection scanning line)
SNL: detection line

1. A sensor-equipped display device comprising a screen that displays an image, and a sensor that detects contact or approach of an object with respect to the screen, the sensor-equipped display device comprising:
a plurality of display scanning lines that are arrayed in a first direction;
a plurality of data lines that are arrayed in a second direction that is different from the first direction;
a plurality of switching elements that are provided in correspondence to points of intersection between the display scanning lines and the data lines, respectively;
a plurality of pixel electrodes that are connected to the switching elements, respectively;
a scanning driving unit that repeats a screen scanning operation with respect to the display scanning lines, the screen scanning operation with respect to the display scanning lines being an operation of selecting the display scanning lines sequentially in the first direction throughout the screen;
a data driving unit that outputs a signal to the data lines in synchronization with the scanning of the display scanning lines by the scanning driving unit, thereby applying, to the pixel electrodes, voltages corresponding to gray levels to be displayed, respectively;
a plurality of detection scanning lines that are arrayed in the first direction;
a plurality of detection lines that are arrayed in the second direction; and
a detection control unit that repeats a screen scanning operation of outputting a driving signal that includes a plurality of pulses, to the detection scanning lines sequentially, and detects signals of the detection lines in correspondence to the driving signal to the detection scanning lines,
wherein the detection control unit is capable of switching a first operation and a second operation from one to the other, wherein the first operation controls timings of the screen scanning operation with respect to the detection scanning lines based on timings of the screen scanning operation with respect to the display scanning lines, and controls timings of the pulses of the driving signal based on timings of signal output to the data lines; and the second operation controls timings of the screen scanning operation with respect to the detection scanning lines based on timings of the screen scanning operation with respect to the display scanning lines, and outputs a driving signal having pulses of a frequency that is different from a frequency of the signal output to the data lines.

2. The sensor-equipped display device according to claim 1,
wherein the frequency of the pulses of the driving signal in the second operation higher than the frequency of the pulses of the driving signal in the first operation.

3. The sensor-equipped display device according to claim 1,
wherein the detection control unit switches the first operation and the second operation from one to the other based on a level of a noise contained in the signal detected at the detection lines.

4. The sensor-equipped display device according to claim 1,
wherein the detection control unit switches the first operation and the second operation from one to the other based on a level of a noise in a frequency range containing the frequency of the pulses of the driving signal in the first operation.

5. The sensor-equipped display device according to claim 1,
wherein the detection control unit switches the first operation to the second operation, when the noise level in the first operation exceeds a preliminarily set range.

6. The sensor-equipped display device according to claim 1,
wherein the detection control unit starts the screen scanning operation with respect to the detection scanning lines, according to a signal generated based on a synchronization signal for controlling the timings of the screen scanning operation with respect to the display scanning lines by the scanning driving unit.

7. The sensor-equipped display device according to claim 6,
wherein the detection control unit controls a timing of starting the screen scanning operation with respect to the detection scanning lines, based on a vertical synchronization signal for controlling the timings of the screen scanning operation with respect to the display scanning lines by the scanning driving unit, and
the detection control unit controls timings of outputting the pulses of the driving signal to the detection scanning lines, respectively, based on a horizontal synchronization signal for controlling the timings of signal output to the data lines.

8. The sensor-equipped display device according to claim 1, further comprising:
a first substrate on which the display scanning lines, the data lines, and the switching elements are arranged;
a second substrate provided so as to be opposed to the first substrate; and
a common electrode provided so as to be opposed to the pixel electrodes,
wherein the detection scanning lines and the detection lines are arranged on at least one of the first substrate and the second substrate, and are provided independently from the common electrode.

9. A control device that controls electronic equipment that includes: a screen having a plurality of pixels arranged in matrix; and a sensor that includes detection scanning lines extending in a row direction of the pixels and detection lines extending in a column direction of the pixels, and detects contact or approach of an object with respect o the screen, the control device comprising:
a signal acquisition unit that receives a vertical synchronization signal for controlling a timing for starting update of display on the screen, and a horizontal synchronization signal for controlling timings for the update of the display of the pixels of the rows on the screen, respectively;
a signal generation unit that generates a signal for controlling the timings of the screen scanning operation with respect to the detection scanning lines, and a signal that is a base of the driving signal having a plurality of pulses to be output to the detection scanning lines; and
an output unit that outputs the driving signal to the detection scanning lines based on the signal generated by the signal generation unit,
wherein the signal generation unit is capable of switching a first operation and a second operation from one to the other, wherein the first operation generates a signal for controlling the timings of the screen scanning operation with respect to the detection scanning lines based on the vertical synchronization signal, and generates a signal for controlling timings of the pulses of the driving signal based on the horizontal synchronization signal; and the second operation generates a signal for controlling the timings of the screen scanning operation with respect to the detection scanning lines based on the vertical synchronization signal, and generates a signal for rating the pulses of the driving signal at a frequency different from a frequency of the horizontal synchronization signal.

10. A control method for controlling electronic equipment that includes: a screen having a plurality of pixels arranged in matrix; and a sensor that includes detection scanning lines extending in a row direction of the pixels and detection lines extending in a column direction of the pixels, and detects contact or approach of an object with respect to the screen, the method comprising:
a signal acquisition step of receiving a vertical synchronization signal for controlling a timing for starting update of display on the screen, and a horizontal synchronization signal for controlling timings for the update of the display of the pixels of the rows on the screen, respectively;
a signal generation step of generating a signal for controlling the timings of the screen scanning operation with respect to the detection scanning lines, and a signal that is a base of the driving signal having a plurality of pulses to be output to the detection scanning lines; and
an output step of outputting the driving signal to the detection scanning lines based on the signal generated in the signal generation step,
wherein in the signal generation step, a first operation and a second operation can be switched from one to the other, wherein the first operation generates a signal for controlling the timings of the screen scanning operation with respect to the detection scanning lines based on the vertical synchronization signal, and generates a signal for controlling timings of the pulses of the driving signal based on the horizontal synchronization signal; and the second operation generates a signal for controlling the timings of the screen scanning operation with respect to the detection scanning lines based on the vertical synchronization signal, and generates a signal for generating the pulses of the driving signal at a frequency different from a frequency of the horizontal synchronization signal.
